(19) United States
(12) Patent Application Publication
(10) Pub. No.: US 2020/0084041 A1
(43) Pub. Date: Mar. 12, 2020

(54) Automated Blockchain Protocol Update

(71) Applicant: Nebulas IO Limited, Road Town (VG)

(72) Inventor: Yiji Xu, Beijing (CN)

(21) Appl. No.: 16/125,555

(22) Filed: Sep. 7, 2018

(51) Int. Cl. H04L 9/32

(52) U.S. Cl. CPC H04L 9/3247; H04L 9/0643

(57) ABSTRACT

Methods, systems, and apparatus, including computer programs encoded on computer storage media, for updating blockchain protocols. One of the methods includes maintaining, by a computing device, a blockchain according to a locally stored first protocol, wherein the blockchain comprises multiple blocks; receiving, by the computing device, a new block to the blockchain, wherein the new block includes information about a second protocol; verifying, by the computing device, that the information about the second protocol is from a trusted source; updating, by the computing device, the locally stored first protocol with the information about the second protocol; and processing, by the computing device, the request using the second protocol implemented using the information about the second protocol in the new block.

### BACKGROUND

A distributed ledger system is a decentralized data storage system with data replicated and synced across multiple computing nodes. A blockchain is a continuously growing list of data records linked and secured using cryptographic technology. A blockchain can be managed by a distributed ledger system, e.g., as a blockchain network, with each computing node in the distributed ledger system adhering to a blockchain protocol for inter-node communication and new blocks validation.

A blockchain network can host decentralized applications that execute across multiple computing nodes. An example decentralized application is a smart contract—a blockchain-based program that automatically executes when a set of specified conditions are met.

A blockchain network decentralizes data storage as every computing node independently maintains an updated copy of the blockchain. Each computing node of the blockchain network independently validates new blocks according to rules specified in the blockchain protocol. However, problems can occur when different computing nodes implement different versions of the blockchain protocol, such as inefficient use of computing resources or forks in the blockchain.

### SUMMARY

This specification describes technologies for automating the update of blockchain protocols. For example, a new block broadcast in the blockchain network can have a protocol code storage area that includes the updated blockchain protocol. Each computing node can host a virtual machine that verifies and implements the included new blockchain protocol. The technologies can further include: maintaining, by a computing device, a blockchain according to a locally stored first protocol, wherein the blockchain comprises multiple blocks; receiving, by the computing device, a new block to the blockchain, wherein the new block includes information about a second protocol; verifying, by the computing device, that the information about the second protocol is from a trusted source; updating, by the computing device, the locally stored first protocol with the information about the second protocol; and processing, by the computing device, the request using the second protocol implemented using the information about the second protocol in the new block.

Particular embodiments of the subject matter described in this specification can be implemented in so as to realize one or more of the following advantages. For example, blockchain forks are avoided by maintaining a common protocol across computing nodes in the blockchain network. As a result, computing resource can be used in a more efficient way to maintain a single blockchain.

The details of one or more embodiments of the subject matter of this specification are set forth in the accompanying drawing and description below. Other features, aspects, and advantages of the subject matter will become apparent from the description, the drawings, and the claims.

### BRIEF DESCRIPTION OF THE DRAWINGS

FIG. 1 is a schematic depiction of an example blockchain.

FIG. 2 is a schematic depiction of an example distributed ledger system.

FIG. 3 is a schematic depiction of an example blockchain fork created by computing nodes executing different versions of blockchain protocol.

FIG. 4 is a schematic depiction of an example blockchain data structure that enables an automated update of blockchain protocol.

FIG. 5 is a flowchart of an example process that automatically updates blockchain protocols in all computing nodes.

Specific embodiments of the invention will now be described in detail with reference to the accompanying figures. Like elements in the various figures are denoted by like reference numerals for consistency.

### DETAILED DESCRIPTION

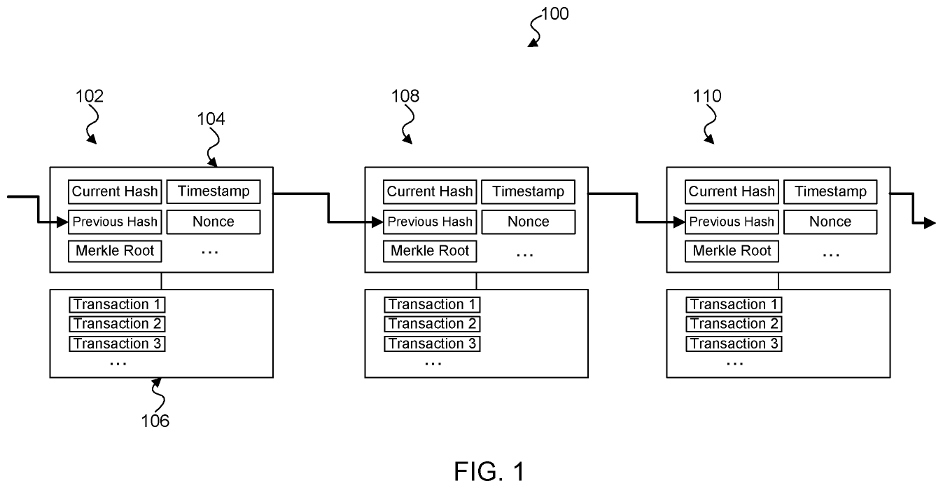

FIG. 1 is a schematic depiction of an example blockchain 100.

A blockchain is a linked list of blocks. Each block is a container data structure including at least (1) a block header and (2) a transaction list. For example, the blockchain 100 includes three example blocks, a block 102, a block 108, and a block 110 linked to each other.

A block header, e.g., the block header 104 for the block 102, includes metadata describing key aspects of the corresponding block. Example block header metadata include current hash, timestamp, previous hash, nonce, Merkle root, etc. Each of these metadata can be represented as a string value. For example, a block header can be represented by table 1:

TABLE 1

| | |
|---|---|
| Current hash | “000000000000000000448b43be29890ca780b |
| | 2b21e2e2a0e53e04269d135abc8” |
| Previous hash | “0000000000000000002e22f7b842d8ec98d67 |
| | e5ae5041e263e3be7e3cea9bbb6” |
| Timestamp | “2018-04-30 19:02:08” |
| Nonce | “2069396004” |
| Merkle Root | “bcd5048e2c5a9960fb285dde4693a3ba7830ea |
| | 69b8cf9876214d31cd321f1dac” |

A transaction list, e.g., the transaction list 106 for the block 102, includes a list of transactions that occurred in a distributed ledger system, e.g., a peer-to-peer blockchain network that implements the blockchain. Each transaction in a transaction list occurred between the current timestamp and the time when the previous block was appended to the blockchain. An example transaction happens when one computing node, e.g., a transaction node, in the blockchain network, sends data, such as digital currency supported by the blockchain, to another computing node in the blockchain network. Another example transaction can include the distribution of digital currency to mining nodes by the blockchain network's consensus. Another example transaction can include a change of state of the current blockchain by the execution of a smart contract.

Each transaction can be described by (1) a sender address in the blockchain network, (2) a receiver address in the blockchain network, (3) transferred data, (4) a timestamp of the transaction, and (5) a unique transaction ID. Each of these fields can be represented as a string value. For example, a transaction can be represented by table 2:

TABLE 2

| | |
|---|---|
| Sender Address | “134Qu1v9KenipLUCnZpC95GrBXh7S6vWog” |
| Receiver Address | “1FC6uZgnctM1BbVoQYZLCcN6o4KrgQZowE” |
| Timestamp | “2018-05-01 05:26:37” |
| Data | “0.6183096 BTC” |
| Transaction ID | “559dc5d4b58371da04c3719819e869a3b70bc336 |
| | 145167d8bf662a480fece9bb” |

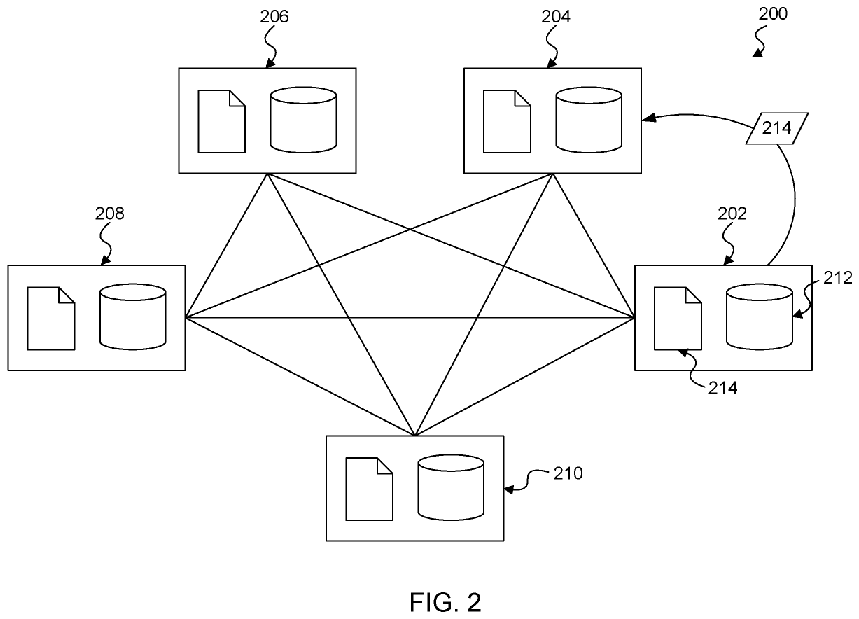

Each transaction will be broadcast to and validated in the blockchain network using a process called mining. Mining will be explained in more details below with reference to FIG. 2.

Current hash is a unique digital identifier of the current block. A hash is a cryptographic digital signature generated by feeding some selected data into a cryptographic hash function. A cryptographic hash function is a special class of hash functions that map data of arbitrary size to a bit string of a fixed size. For example, the cryptographic hash function used in table 1 has an output of a 32-bit string value. A cryptographic hash function useful for a blockchain is typically required to have five main properties:
1. It is deterministic so that the same data will result in the same hash.
2. It is quick to compute.
3. It is infeasible to recreate the data from its hash except by trying all possible messages.
4. A small change in the data will change the hash extensively.
5. It is infeasible to find two different data with the same hash value.

An example cryptographic hash function is the SHA-256 algorithm, which is used by the Bitcoin blockchain network. Other example cryptographic hash functions include BLAKE, BLAKE2, KECCAK-256, CryptoNight, etc.

Current hash is calculated by feeding block data, e.g., string values in the block header and the transaction list, to a cryptographic hash function specified in the blockchain protocol. Given that each block has unique block data and that it is infeasible to find two different data with the same hash value (property 5 mentioned above), current hash is unique for every block.

Previous hash is a hash pointer which points to the previous block. Previous hash has a value equivalent to current hash of the previous block. As a result, except for the very first block, each block is connected to another block (the first block, or the “genesis block,” is generated automatically by the blockchain protocol). This design causes data on a blockchain to be immutable. For example, if a hacker wishes to change data in one block, data in all blocks must be changed since every block contains a bit of hashed information from another block, and a small change in the data will change the hash extensively.

Timestamp identifies the time when the current block was appended to the blockchain. Computing nodes can reference a dedicated time-reporting server to record consistent timestamp across the blockchain network.

Nonce is an arbitrary random value that is used in the cryptographic hash function to control the hash output. In order to add a new block to a blockchain, a special type of computing node “mining node” randomly chooses a nonce value and repeatedly hashes the block data including the chosen nonce till the hash output satisfies a specified condition. For example, the condition for adding a new block shown in table 1 is that the hash output (current hash) must have eighteen leading “0 s.” Details on the process of adding a block to a blockchain are described below with reference to FIG. 2.

Merkle root is the top hash value produced by feeding data in a transaction list into a Merkle tree. A Merkle tree is a binary tree in which every leaf node is a hash of a data block and every non-leaf node is a hash of its two child nodes. Merkle root uniquely identifies the list of transactions associated with each block.

In some implementations, a reward is given to the mining node which first discovered a nonce to satisfy the specified condition for appending blocks. For example, the reward can be some digital currency specified by the blockchain. This incentives users to participate as mining nodes in the blockchain network to spend computing resources to compete in the so-called mining process described below. Each mining node maintains a copy of the blockchain locally, and communicates with other mining nodes to broadcast and validate new transactions.

FIG. 2 is a schematic depiction of an example distributed ledger system.

A distributed ledger system is a decentralized data storage system with data replicated and synced across multiple computing nodes. For example, a distributed ledger system can be implemented as a blockchain network. A blockchain network is a network of computing nodes set to maintain a blockchain, e.g., the blockchain 100 of FIG. 1, according to a specified blockchain protocol. For example, FIG. 2 shows a blockchain network 200 including five computing nodes 202, 204, 206, 208, and 210. Each computing node is independent from and connected to every other node. Computing nodes can assume different functions such as mining nodes, transaction nodes, decentralized applications, etc.

Each computing node includes a runtime that executes a specified blockchain protocol, e.g., a protocol 214 in the computing node 202. The blockchain protocol specifies rules including the conditions for allowing a mining node to add a new block to the blockchain, the frequency of adding new blocks, the type of data included in a block, or the amount of rewards to be distributed for appending the blockchain, etc.

Each computing node also includes a data storage area, e.g., a data storage area 212 of the computing node 202, for storing current information of the blockchain.

In some implementations, the blockchain network comprises one or more transaction nodes. Transaction nodes are a type of computing nodes in the blockchain network that do not implement the full blockchain protocol. For example, a transaction node does not spend computing resource to validate other transactions, but rely on mining nodes for such a task. A transaction node functions exclusively to send and receive data in the blockchain network with other computing nodes.

A transaction in the blockchain network is initiated when a transfer of data occurs. For example, the blockchain maintained in the blockchain network 200 can be a record of digital currency transactions among computing nodes. Each of the computing nodes 202, 204, 206, 208 and 210 can act as a transaction node and/or a mining node. That is to say, each of the computing nodes in FIG. 2 can both send and receive data, and validate new blocks to the blockchain. The computing node 202 can initiate a transaction 214 by sending some amount of digital currency to the computing node 204.

To have the blockchain record the transaction 214, the computing node 202 broadcasts this transaction to every other computing node in the blockchain network 200. Another computing node, e.g., the computing node 210, receives the transaction and performs two different tasks. First, the computing node 210 will verify that the transaction 214 is a valid transaction. For example, the computing node 210 can look into records in the existing blockchain to verify that the computing node 202 has the sufficient amount of digital currency to transfer to the computing node 204. Next, the computing node 210 initiates a “mining” process in an attempt to become the first node to add this transaction to the blockchain.

Mining is a process in which a computing node spends computing resource to search for a special string (nonce) that causes the hash output of the block (current hash) to satisfy a specified condition. If a computing node is the first node to find the appropriate nonce, then the computing node is given certain rewards and the transaction is appended to the blockchain after other computing nodes validate the proposed nonce. Each computing node's mining power is limited by its specific computer architecture. For example, a computing node with a faster CPU clock rate has greater mining power compared to one with a slower clock rate.

As an example condition, for a block with some new transactions to be added to the blockchain, a nonce must be found such that when the nonce combined with other data in the block header and transaction list, and fed to the cryptographic hash function (e.g. SHA-256), the output string must begin with a certain number of leading “0 s.” Since it is infeasible to recreate the data from its hash except by trying all possible inputs (property 3 of hash function), there only exists a brute force solution and it takes a very large number of trials to find the right nonce.

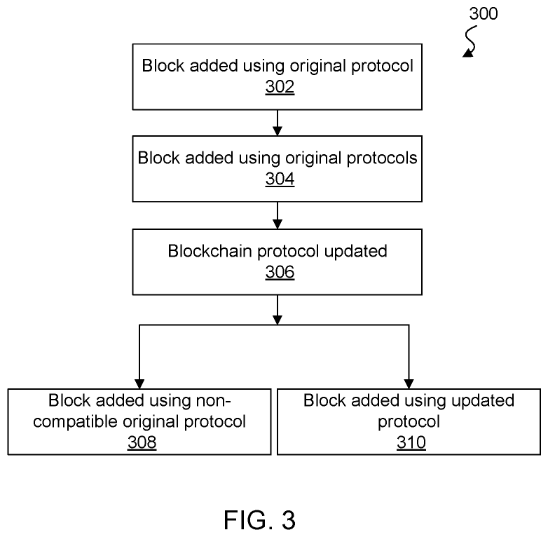

In some implementations, a computing node's mining power is restricted by conditions such as the amount of digital currency held by the computing node, or the rank of the computing node in the blockchain network. For example, a computing node that holds 1% of all available digital currency supported by the blockchain network can only mine at most 1% of all new blocks. In another example, a computing node with a higher rank in a blockchain network receives reduced mining difficulty compared to a node with lower rank. Ranking of computing nodes in a blockchain network is described below with respect to FIG. 3.

If the computing node 202 does have sufficient digital currency, and the computing node 210 is the first computing node to find the correct nonce, the computing node 210 will broadcast its finding to every other computing node in the blockchain. If the nonce and the transactions in the new block are validated, the new block will be added to the blockchain. Each computing node in the blockchain network will have an updated copy of the blockchain.

FIG. 3 is a schematic depiction of an example blockchain fork due to computing nodes executing different versions of a blockchain protocol. For example, the blockchain protocol can specify data structure for each block in a blockchain and the steps each computing node takes when receiving a new block. Different versions of the blockchain protocol can produce incompatible block data structure and cause computing nodes to split to building different branches stemming from the original blockchain. For example, one group of computing nodes is operating under one protocol, and a different group of computing nodes is operating under a different protocol. As a result, the two groups will not accept blocks mined from each other.

New blocks are added to a blockchain using the original blockchain protocol (302 and 304). The original blockchain protocol provides instructions for computing nodes in the blockchain network to mine blocks, i.e., to add new blocks to the blockchain. For example, the original blockchain protocol can specify the number of transactions to be included per block, the mining difficulty, the consensus algorithm to be used, etc. Since the blocks in step 302 and 304 are added to the blockchain using the same blockchain protocol, they share data structure and have been verified by all computing nodes in the blockchain network.

The blockchain protocol is updated (306). In theory, a person can modify the blockchain protocol and execute the protocol on his/her computing node. In practice, however, the effectiveness and the degree of decentralization of a blockchain network depend on the network's scale, and the protocol update is only meaningful if a large number of computing nodes have implemented the changes. Depending on the nature of the protocol update, a different number of computing nodes in the blockchain network may have decided to adopt the changes.

In some implementations, every computing node will adopt the blockchain protocol update since it is beneficial to all. For example, the protocol update can include fixes to critical security bugs. Even though all computing nodes are likely to accept such updates, the actual adoption can be inefficient and cause a waste of computing resources. For example, a computing node that has not yet received the update will keep mining blocks according to the outdated protocol. As a result, the mined blocks will be incompatible with those produced by the updated protocol, and the computing node will not receive any rewards because all of its mining efforts are rejected by other updated computing nodes. When the computing node eventually installs the updates, it will start mining and adding blocks to the blockchain using the updated protocol (310).

In some implementations, a large number of computing nodes do not implement the protocol update and continue to mine using the old protocol. For example, sometimes the blockchain protocol is updated to include new features. This can cause a split in opinions in the blockchain community since not every computing node administrator is approving the new features. For example, a new feature can improve the blockchain's transaction rate while reducing the network's degree of decentralization. Computing node administrators who emphasize decentralization over transaction speed may be unwilling to implement these changes. A fork in the blockchain occurs when at least some computing nodes start implementing the protocol update. The computing nodes that do not implement the update will continue running the old blockchain protocol (308).

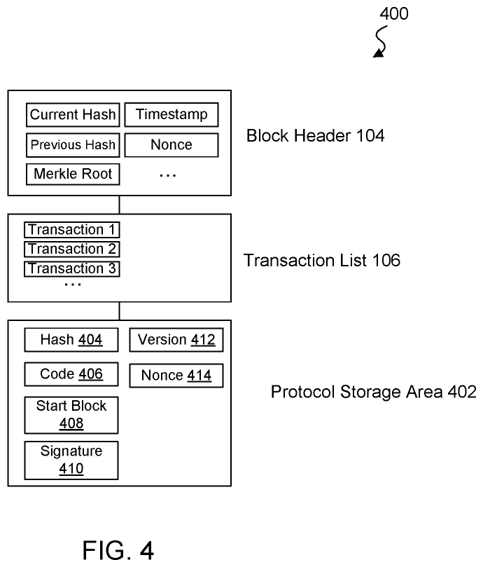

FIG. 4 is a block diagram of an example blockchain data structure that enables automated blockchain protocol update. In addition to the blockchain header 104 (FIG. 1) and the transaction list 106 (FIG. 1) as described in FIG. 1, a block 400 includes a protocol storage area 402. The blockchain data structure including the protocol storage area 402 helps to avoid blockchain forks by allowing each computing node to receive the latest blockchain protocol before mining blocks.

The protocol storage area 402 is responsible for storing data related to an updated blockchain protocol. For example, the protocol storage area 402 can include a binary of the updated blockchain protocol. When a computing node in a blockchain network receives a new block for mining, e.g., the block 400, the computing node is programmed to first check data stored in the protocol storage area 402. If the protocol storage area 402 includes a new binary, the computing node will update its blockchain protocol before start mining.

In some implementations, the protocol storage area 402 includes a plurality of data fields such as a hash 404, a code 406, a start block 408, a signature 410, a version 412, and a nonce 414.

The hash 404 is an identifier of the protocol storage area 402. For example, the hash 404 can be produced by hashing the data included in the protocol storage area 402 using the same cryptographic hash algorithm that produces current hash in the block header 104. The hash 404 is used to verify whether the protocol code has been changed or modified by an attacker, e.g., a man-in-the-middle attack. When the protocol code is broadcast to the blockchain network, any computing node can perform a hash calculation to verify if the result matches the hash 404.

The code 406 is a data field that stores the latest updated protocol code. For example, the code 406 can store compiled byte code for the entire new blockchain protocol. Using byte code allows the protocols or smart contracts to be written in multiple programming languages that can be converted into byte code. In another example, the code 406 can store only changes committed relative to a prior version of the blockchain protocol. In some implementations, a virtual machine running on a computing node can execute the byte code to update the node's protocol code. The virtual machine can provide a consistent instruction set architecture for each host computer, which allows the byte code to be executed on computing nodes with different instruction set architectures. In order to prevent a fork from happening, only a designated team of developers is given the authority to implement protocol changes and to include the update in the code 406. Computing nodes in the blockchain network can use a public key to verify that the update is indeed from a legitimate source. For example, the public key can be stored in the first block (genesis block) of the blockchain.

If no update has been made, the code 406 includes no data and a computing node will use the previously installed blockchain protocol to mine new blocks.

The start block 408 identifies the first block for which the new protocol will be used. For example, each block in the blockchain can be labeled sequentially, and the start block 408 indicates the position in the blockchain.

The signature 410 is a reserved signature to verify that the protocol update is from the designated team of developers. For example, the signature process can be based on asymmetric cryptography with the public key stored in the blockchain and the private key kept in secret by the designated developers.

The version 412 records the current version of the protocol code.

The nonce 414 serves as a counter recording the number of times the protocol code has been updated and deployed to the blockchain. The nonce 414 is different from the nonce recorded in the block header. The nonce 414 is also different from the version 412 since the same version of the protocol code can have been deployed multiple times.

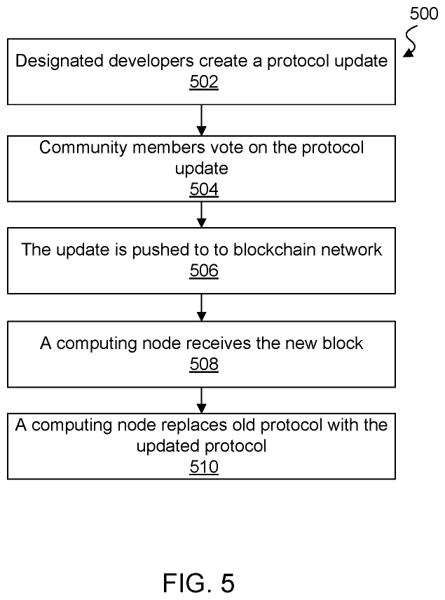

FIG. 5 is a flowchart of an example process 500 that automatically updates blockchain protocols for a computing node in a blockchain network.

Designated developers create a protocol update (502). For example, the update can include changes in block protocol that fix known security risk or include new features in the blockchain. The designated developers can be the original developers of the blockchain, and keep a secret key for verification purpose.

Community members vote on the protocol update (504). To promote transparency in the blockchain protocol update process, the designated developers can publish the updated blockchain protocol for the rest of the community to review. For example, the blockchain protocol can be published in a community forum to receive feedback. Community members, such as owners of computing nodes in the blockchain network, can vote on the updated protocols. In some implementations, the voting can be conducted on the blockchain as each block includes data field recording a computing node's approval or disapproval. If at least a specified number of computing nodes have approved the updates, the updated protocol will be included in new blocks and implemented in the entire blockchain network.

The update is pushed to the blockchain network (506). Once the protocol change receives enough votes, the designated developers can push the updates to the blockchain network. For example, the designated developers can include the binary of the updated protocol in the protocol code storage area 402 (FIG. 4) in a new block, and broadcast the new block in the blockchain network. To verify that the update is indeed from the designated developers, the developers can sign the protocol update with a secret key that allows other computing nodes to verify.

A computing node receives the new block with updated blockchain protocol (508). Once the updated protocol has been approved, a block with the corresponding protocol storage area 402 (FIG. 4) will be broadcast to the blockchain network. Similar to the mining process described in FIG. 2, computing nodes in the blockchain network will receive the new block with the updated protocol. A computing node will first verify that the protocol is from a legitimate source by verifying the signature 410 (FIG. 4).

A computing node replaces an old protocol with the updated protocol (510). A computing node is only allowed to start the mining process after it replaces the old blockchain protocol with the updated protocol. As a result, a computing node avoids wasting computing resources executing an outdated blockchain protocol.

Embodiments include corresponding computer systems, apparatus, and computer programs recorded on one or more computer storage devices, each configured to perform the actions described in the processes above. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the operations described in this document can be implemented in digital electronic circuitry, or in computer software, firmware, or hardware, including the structures disclosed in this document and their structural equivalents, or in combinations of one or more of them. Embodiments of the subject matter described in this document can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this document can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other units suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this document can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this document can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this document, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
maintaining, by a computing device, a blockchain according to a locally stored first protocol, wherein the blockchain comprises multiple blocks;
receiving, by the computing device, a new block to the blockchain, wherein the new block includes information about a second protocol;
verifying, by the computing device, that the information about the second protocol is from a trusted source;
updating, by the computing device, the locally stored first protocol with the information about the second protocol; and
processing, by the computing device, the request using the second protocol implemented using the information about the second protocol in the new block.

2. The method of claim 1, wherein the new block includes a digital signature, and wherein verifying that the information about the second protocol is from a trusted source comprises verifying the digital signature in the new block.

3. The method of claim 2, wherein verifying the digital signature comprises using a public key included in the first block of the blockchain.

4. The method of claim 1, further comprising:
receiving, by the computing device, a second request to add a second new block to the blockchain, wherein the second new block does not include information about a protocol; and
processing the second new block using information in the second protocol.

5. The method of claim 1, wherein the information about the second protocol comprises compiled bytecode to be executed on a virtual machine hosted by the computing device.

6. The method of claim 1, wherein the information about the second protocol indicates the position on the blockchain from which the second protocol will be executed.

7. A system comprising one or more computers and one or more storage devices storing instructions that when executed by the one or more computers cause the one or more computers to perform operations comprising:
maintaining a blockchain according to a locally stored first protocol, wherein the blockchain comprises multiple blocks;
receiving a new block to the blockchain, wherein the new block includes information about a second protocol;
verifying that the information about the second protocol is from a trusted source;
updating the locally stored first protocol with the information about the second protocol; and
processing the request using the second protocol implemented using the information about the second protocol in the new block.

8. The system of claim 7, wherein the new block includes a digital signature, and wherein verifying that the information about the second protocol is from a trusted source comprises verifying the digital signature in the new block.

9. The system of claim 7, wherein verifying the digital signature comprises using a public key included in the first block of the blockchain.

10. The system of claim 7, further comprising:
receiving, by the computing device, a second request to add a second new block to the blockchain, wherein the second new block does not include information about a protocol; and
processing the second new block using information in the second protocol.

11. The system of claim 7, wherein the information about the second protocol comprises compiled bytecode to be executed on a virtual machine hosted by the computing device.

12. The system of claim 7, wherein the information about the second protocol indicates the position on the blockchain from which the second protocol will be executed.

13. The system of claim 7, wherein the information about the second protocol comprises relative code changes with respect to the first protocol.

14. A non-transitory computer storage medium encoded with a computer program, the computer program storing instructions that when executed by one or more computers cause the one or more computers to perform operations comprising:
maintaining a blockchain according to a locally stored first protocol, wherein the blockchain comprises multiple blocks;
receiving a new block to the blockchain, wherein the new block includes information about a second protocol;
verifying that the information about the second protocol is from a trusted source;
updating the locally stored first protocol with the information about the second protocol; and
processing the request using the second protocol implemented using the information about the second protocol in the new block.

15. The non-transitory computer storage medium of claim 14, wherein the new block includes a digital signature, and wherein verifying that the information about the second protocol is from a trusted source comprises verifying the digital signature in the new block.

16. The non-transitory computer storage medium of claim 14, wherein verifying the digital signature comprises using a public key included in the first block of the blockchain.

17. The non-transitory computer storage medium of claim 14, further comprising:
receiving, by the computing device, a second request to add a second new block to the blockchain, wherein the second new block does not include information about a protocol; and
processing the second new block using information in the second protocol.

18. The non-transitory computer storage medium of claim 14, wherein the information about the second protocol comprises compiled bytecode to be executed on a virtual machine hosted by the computing device.

19. The non-transitory computer storage medium of claim 14, wherein the information about the second protocol indicates the position on the blockchain from which the second protocol will be executed.

20. The non-transitory computer storage medium of claim 14, wherein the information about the second protocol comprises relative code changes with respect to the first protocol.
